(19) United States
(12) Patent Application Publication
(10) Pub. No.: US 2013/0033527 A1
(43) Pub. Date: Feb. 7, 2013

(54) DRIVING APPARATUS FOR DISPLAY AND DRIVING METHOD THEREOF

(71) Applicant: Chih-Jen Yen, Hsinchu City (TW)

(72) Inventor: Chih-Jen Yen, Hsinchu City (TW)

(73) Assignee: Novatek Microelectronics Corp., Hsinchu (TW)

(21) Appl. No.: 13/489,469

(22) Filed: Jun. 6, 2012

(30) Foreign Application Priority Data
Aug. 5, 2011 (TW) 100127945

(51) Int. Cl. G09G 5/10

(52) U.S. Cl. 345/690

(57) ABSTRACT

A driving apparatus for display and a driving method thereof are provided. The driving apparatus includes a display data detector, a power controller and a source driver. The display data detector is used for detecting a plurality of display data and generating a control signal according to a maximal value of the display data, in which the display data are corresponding to a plurality of gamma voltages. The power controller is for receiving the control signal and providing a driving power according to the control signal. The source driver is for receiving the driving power as an operation power and generating a driving voltage corresponding to each of the display data according to the driving power and each of the gamma voltages.

### CROSS-REFERENCE TO RELATED APPLICATION

This application claims the priority benefit of Taiwan application serial no. 100127945, filed on Aug. 5, 2011. The entirety of the above-mentioned patent application is hereby incorporated by reference herein and made a part of this specification.

### BACKGROUND OF THE INVENTION

1. Field of the Invention

The invention generally relates to a driving apparatus for display and a driving method thereof, and more particularly, to a driving apparatus for display and a driving method thereof able to save power consumption.

2. Description of Related Art

FIG. 1 is a block diagram of a conventional driving apparatus for display.

Referring to FIG. 1, a display 100 includes a display panel 110, a clock controller 120, a power controller 130, a gate driver 140 and a source driver 150. The clock controller 120 receives a display data DATAIN and respectively provides the gate driver 140 and the source driver 150 with two clock-controlling signals HT1 and VT1. The gate driver 140 and the source driver 150 transmit driving signals for driving the display panel 110 respectively according to the received clock-controlling signals HT1 and VT1. The source driver 150 further adjusts the voltage value of the driving signal provided to the display panel 110 according to the voltage value of the gamma voltage corresponding to the display data DATAIN so that the pixels on the display panel 110 can display different luminance.

In the conventional display 100, the operation power of the source driver 150 is a driving power POW provided by the power controller 130. In order to make the display panel 110 display different luminance by using the source driver 150, the driving power POW provided by the power controller 130 often has a fixed and higher voltage value (for example, slightly higher than the driving voltage required by the maximal gray level of the display panel 110). According to the scheme, when the luminance displayed by the display 100 is reduced, the power controller 130 still needs to persistently produce the driving power POW which a relatively-high voltage level. Hence, unnecessary power consumption is resulted.

### SUMMARY OF THE INVENTION

Accordingly, the invention is directed to a driving apparatus for display and a driving method thereof which can effectively reduce the consumed power during driving.

The present invention provides a driving apparatus for display, which includes a display data detector, a power controller and a source driver. The display data detector is used for detecting a plurality of display data and generating a control signal according to a maximal value of the display data, in which the display data are corresponding to a plurality of gamma voltages. The power controller is coupled to the display data detector for receiving the control signal and providing a driving power according to the control signal. The source driver is coupled to the power controller for receiving the driving power as an operation power and generating a driving voltage corresponding to each of the display data according to the driving power and each of the gamma voltages.

In an embodiment of the present invention, the above-mentioned gamma voltages include a plurality of positive-polarity gamma voltages and a plurality of negative-polarity gamma voltages, the control signal includes a positive-polarity control signal and a negative-polarity control signal and the driving power includes a positive-polarity driving power and a negative-polarity driving power.

In an embodiment of the present invention, the above-mentioned display data detector calculates the positive-polarity gamma voltages and the negative-polarity gamma voltages corresponding to the display data, and the display data detector generates the positive-polarity control signal and the negative-polarity control signal respectively according to a maximal value among the differences between the positive-polarity gamma voltages and the common voltage and a maximal value among the differences between the negative-polarity gamma voltages and the common voltage.

In an embodiment of the present invention, the above-mentioned power controller includes a positive-polarity power generating circuit and a negative-polarity power generating circuit. The positive-polarity power generating circuit is coupled to the display data detector, receives the positive-polarity control signal and generates the positive-polarity driving power according to the positive-polarity control signal. The negative-polarity power generating circuit is coupled to the display data detector, receives the negative-polarity control signal and generates the negative-polarity driving power according to the negative-polarity control signal.

In an embodiment of the present invention, the above-mentioned positive-polarity power generating circuit includes a first voltage-dividing circuit and a first unity-gain amplifier. The first voltage-dividing circuit receives the positive-polarity control signal, performs voltage-dividing on the voltage source according to the positive-polarity control signal and generates a first divided voltage. The first unity-gain amplifier is coupled to the first voltage-dividing circuit and receives the first divided voltage so as to generate the positive-polarity driving power. The negative-polarity power generating circuit includes a second voltage-dividing circuit and a second unity-gain amplifier. The second voltage-dividing circuit receives the negative-polarity control signal, performs voltage-dividing on a voltage source according to the negative-polarity control signal and generates a second divided voltage. The second unity-gain amplifier is coupled to the second voltage-dividing circuit and receives the second divided voltage so as to generate the negative-polarity driving power.

In an embodiment of the present invention, the above-mentioned positive-polarity power generating circuit includes a first operational amplifier and a first feedback circuit. The first input terminal of the first operational amplifier receives a first reference voltage, and the output terminal thereof generates the positive-polarity driving power. The first feedback circuit is electrically connected in series between the output terminal of the first operational amplifier and the second input terminal of the first operational amplifier for performing voltage-dividing on the positive-polarity driving power according to the positive-polarity control signal so as to generate a first divided voltage, and the first feedback circuit further transmits the first divided voltage to the second input terminal of the first operational amplifier. The negative-polarity power generating circuit includes a second operational amplifier and a second feedback circuit. The first input terminal of the second operational amplifier receives a second reference voltage, and the output terminal thereof generates the negative-polarity driving power. The second feedback circuit is electrically connected in series between the output terminal of the second operational amplifier and the second input terminal of the second operational amplifier for performing voltage-dividing on the negative driving power according to the negative-polarity control signal so as to generate a second divided voltage, in which the second feedback circuit further transmits the second divided voltage to the second input terminal of the second operational amplifier.

In an embodiment of the present invention, the above-mentioned positive-polarity power generating circuit includes a power converter. The power converter is coupled to the display data detector, receives the positive-polarity control signal, and performs a voltage-boosting operation on an input voltage according to the positive-polarity control signal so as to generate the positive-polarity driving power.

In an embodiment of the present invention, the above-mentioned negative-polarity power generating circuit includes a first operational amplifier and a first feedback circuit. The first input terminal of the first operational amplifier receives a first reference voltage, and the output terminal thereof generates the negative-polarity driving power. The first feedback circuit is electrically connected in series between the output terminal of the first operational amplifier and the second input terminal of the first operational amplifier for performing voltage-dividing on the negative-polarity driving power according to the negative-polarity control signal so as to generate a first divided voltage, in which the first feedback circuit further transmits the first divided voltage to the second input terminal of the first operational amplifier, and the first operational amplifier receives the positive-polarity driving power as the operation power thereof.

In an embodiment of the present invention, the above-mentioned negative-polarity power generating circuit includes a first voltage-dividing circuit and a first unity-gain amplifier. The first voltage-dividing circuit receives the negative-polarity control signal, performs voltage-dividing on the negative-polarity driving power according to the negative-polarity control signal and generates a first divided voltage. The first unity-gain amplifier is coupled to the first voltage-dividing circuit and receives the first divided voltage so as to generate the negative-polarity driving power, in which the first unity-gain amplifier receives the positive-polarity driving power as the operation power thereof.

In an embodiment of the present invention, the above-mentioned power converter includes a power converting circuit, a voltage-dividing circuit, an error amplifier and a pulse-width modulation signal generating circuit. The power converting circuit receives an input voltage, has a power transistor, and performs a voltage-boosting operation on the input voltage according to turning on and turning off of the power transistor and thereby generates the positive-polarity driving power. The voltage-dividing circuit is coupled to the power converting circuit and performs voltage-dividing on the positive-polarity driving power according to the positive-polarity control signal. The input terminal of the error amplifier respectively receives a voltage-dividing result of the voltage-dividing circuit and a reference voltage. The pulse-width modulation signal generating circuit is coupled to the output terminal of the error amplifier and generates a pulse-width modulation signal according to the voltage at the output terminal of the error amplifier, in which the pulse-width modulation signal is for turning on or off the power transistor.

In an embodiment of the present invention, the above-mentioned power converter includes a power converting circuit, a voltage-dividing circuit, an error amplifier and a pulse-width modulation signal generating circuit. The power converting circuit receives the input voltage, has a power transistor, performs the voltage-boosting operation on the input voltage according to turning on and turning off of the power transistor and thereby generates the positive-polarity driving power. The voltage-dividing circuit is coupled to the power converting circuit and performs voltage-dividing on the positive-polarity driving power. The input terminal of the error amplifier respectively receives a voltage-dividing result of the voltage-dividing circuit and a reference voltage, in which the reference voltage is adjusted according to the positive-polarity control signal. The pulse-width modulation signal generating circuit is coupled to the output terminal of the error amplifier and generates a pulse-width modulation signal according to the voltage at the output terminal of the error amplifier, in which the pulse-width modulation signal is for turning on or off the power transistor.

In an embodiment of the present invention, the above-mentioned positive-polarity power generating circuit and negative-polarity power generating circuit respectively include a power converter. The power converter includes a power converting circuit, a voltage-regulating capacitor, a voltage-dividing circuit, an error amplifier and a pulse-width modulation signal generating circuit. The power converting circuit receives the input voltage, has a power transistor and performs the voltage-boosting operation on the input voltage according to turning on and turning off of the power transistor. The voltage-dividing circuit is coupled to the power converting circuit and performs voltage-dividing on the positive-polarity driving power. The input terminal of the error amplifier respectively receives a voltage-dividing result of the voltage-dividing circuit and a reference voltage. The pulse-width modulation signal generating circuit is coupled to the output terminal of the error amplifier and generates a pulse-width modulation signal according to the voltage at the output terminal of the error amplifier, in which the pulse-width modulation signal is for turning on or off the power transistor. The voltage-regulating capacitor receives the positive-polarity control signal and the negative-polarity control signal and generates the positive-polarity driving power and the negative-polarity driving power respectively according to the positive-polarity control signal and the negative-polarity control signal.

The present invention also provides a driving method of display, which includes following steps: first, detecting a plurality of display data and generating a control signal according to a maximal value of the display data; next, providing a driving power according to the control signal; then producing a driving voltage corresponding to each of the display data according to the driving power and each of the gamma voltages corresponding to each of the display data.

Based on the description above, in the present invention, the display data to be displayed by a display are detected and a corresponding control signal is generated according to the maximal value of the gamma voltages generated by the display data. The driving power generated by the power controller is controlled through the control signal so that the source driver receives the driving power as an operation voltage to provide a corresponding driving voltage to drive the display. In this way, the driving power of the source driver can be dynamically adjusted according to the voltage level of the driving voltage to be generated without keeping provide the highest driving power voltage to the source driver, which effectively reduces the energy consumption.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a block diagram of a conventional driving apparatus for display.

FIG. 2 is a schematic diagram of a driving apparatus for display according to an embodiment of the invention.

FIG. 3 is a schematic diagram showing an implementation of the power controller of the embodiment of the invention.

FIGS. 4A-4F are schematic diagrams showing different implementations of the positive-polarity power generating circuit and the negative-polarity power generating circuit in the embodiment of the invention.

FIG. 5 is a flowchart of a driving method of display according to an embodiment of the invention.

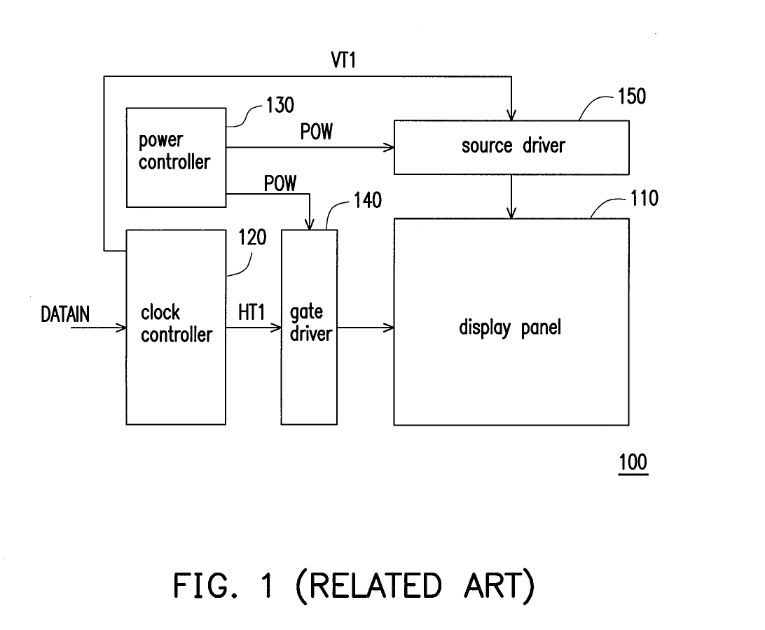

### DESCRIPTION OF THE EMBODIMENTS

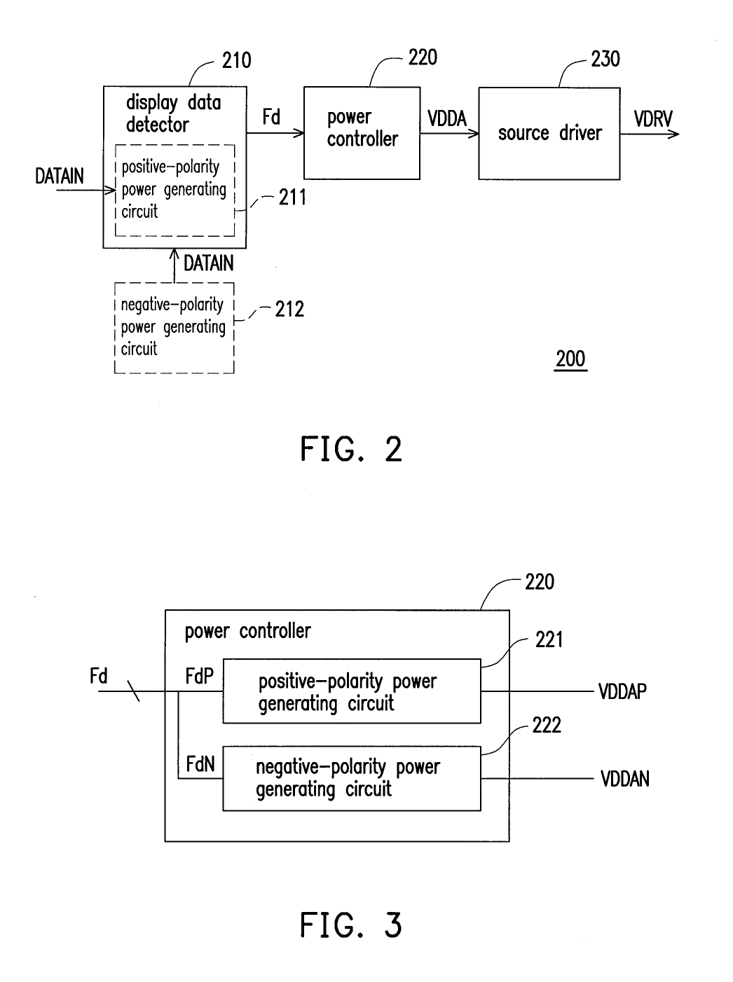

FIG. 2 is a schematic diagram of a driving apparatus for display according to an embodiment of the invention. Referring to FIG. 2, a driving apparatus 200 includes a display data detector 210, a power controller 220 and a source driver 230. The display data detector 210 is for detecting a plurality of display data DATAIN and generating a control signal Fd according to the maximal value of the detected display data DATAIN. The quantity of the display data DATAIN can be data amount for displaying one frame or multiple frames or data amount for displaying one display row or multiple display rows, and a designer can set the quantity according to the real requirement. The display data DATAIN can be transmitted to a built-in memory unit 211 of the display data detector 210 and registered in the memory unit 211 for the display data detector 210 to read, or the display data detector 210 reads the display data DATAIN through an external memory unit 212 instead of the built-in memory unit 211 (at the situation, the display data DATAIN need to be registered in the memory unit 212).

After the display data detector 210 has detected out the maximal value among the display data DATAIN, the display data detector 210 can use the gamma voltage corresponding to the maximal value of the display data DATAIN to obtain the maximal voltage value of a driving voltage VDRV output from the source driver 230 so as to produce the control signal Fd and transmits the control signal Fd to the power controller 220 according to the detected maximal value among the display data DATAIN.

It should be noted that since each of the display data DATAIN is corresponding to two gamma voltages with two different polarities (a positive-polarity gamma voltage and a negative-polarity gamma voltage), and the absolute values of the two positive-polarity and negative-polarity gamma voltages both corresponding to a same display data DATAIN are not necessarily the same as each other, and therefore the control signal Fd generated by the display data detector 210 can include a positive-polarity control signal and a negative-polarity control signal.

The display data detector 210 calculates the positive-polarity gamma voltages corresponding to all the display data DATAIN, finds out the maximal value among the differences between the positive-polarity gamma voltages and a common voltage and produces the positive-polarity control signal according to the maximal difference value. The display data detector 210 further calculates the negative-polarity gamma voltages corresponding to all the display data DATAIN, finds out the maximal value among the differences between the negative-polarity gamma voltages and the common voltage and produces the negative-polarity control signal according to the maximal difference value.

The power controller 220 is coupled to the display data detector 210 for receiving the control signal Fd and provides a driving power VDDA according to the control signal Fd. When the control signal Fd includes a positive-polarity control signal and a negative-polarity control signal, the power controller 220 is corresponding to two control signals with positive polarity and negative polarity to respectively generate a positive-polarity driving power and a negative-polarity driving power. That is to say, when the control signal Fd includes a positive-polarity control signal and a negative-polarity control signal, the driving power VDDA includes a positive-polarity driving power and a negative-polarity driving power.

The source driver 230 is coupled to the power controller 220 and receives the driving power VDDA as the operation power thereof. The source driver 230 then produces a driving voltage VDRV corresponding to the gamma voltage related to each of the display data DATAIN according to the driving power VDDA. It can be seen from the description above that the absolute value of the driving voltage VDRV would not be greater than the driving power VDDA.

FIG. 3 is a schematic diagram showing an implementation of the power controller of the embodiment of the invention. Referring to FIG. 3, the power controller 220 includes a positive-polarity power generating circuit 221 and a negative-polarity power generating circuit 222. The positive-polarity power generating circuit 221 receives a positive-polarity control signal FdP in the control signal Fd, while the negative-polarity power generating circuit 222 receives a negative-polarity control signal FdN therein. The positive-polarity power generating circuit 221 and the negative-polarity power generating circuit 222 simultaneously and respectively generate a positive-polarity driving power VDDAP and a negative-polarity driving power VDDAN according to the positive-polarity control signal FdP and the negative-polarity control signal FdN.

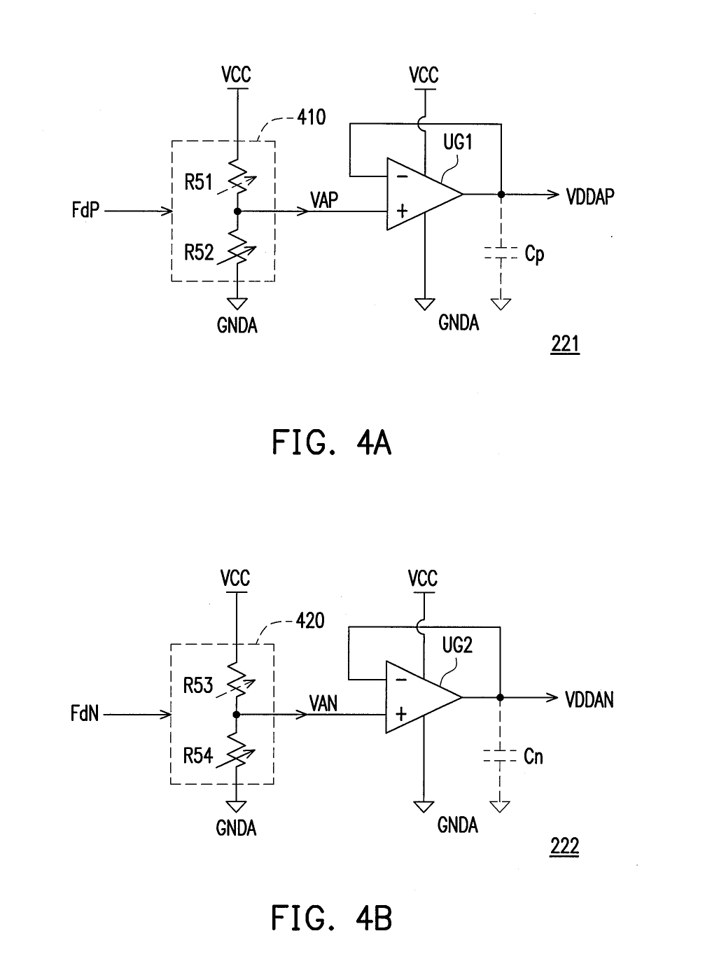

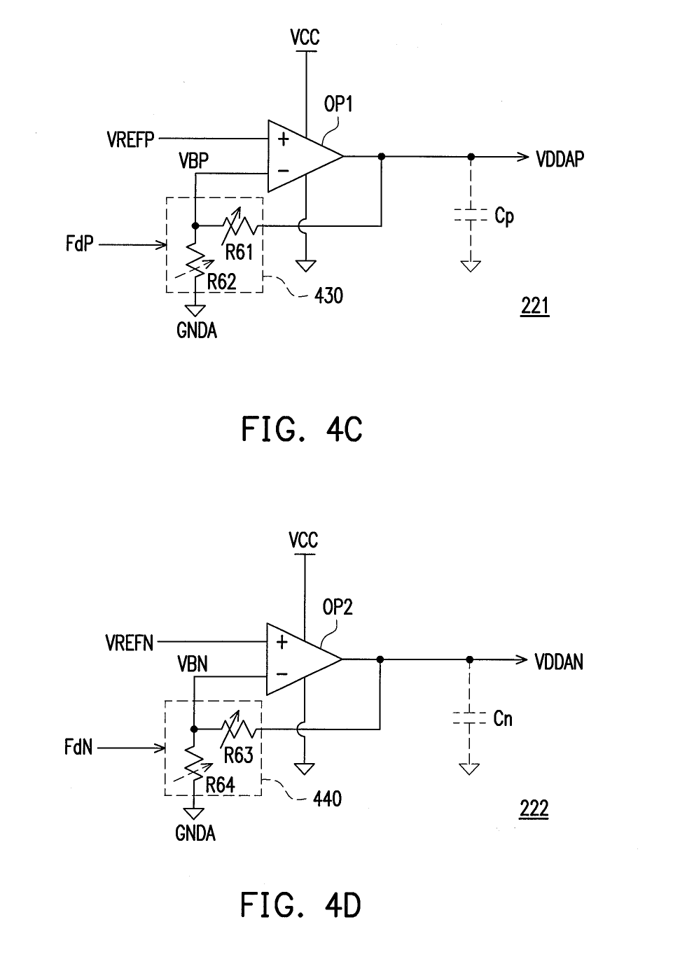

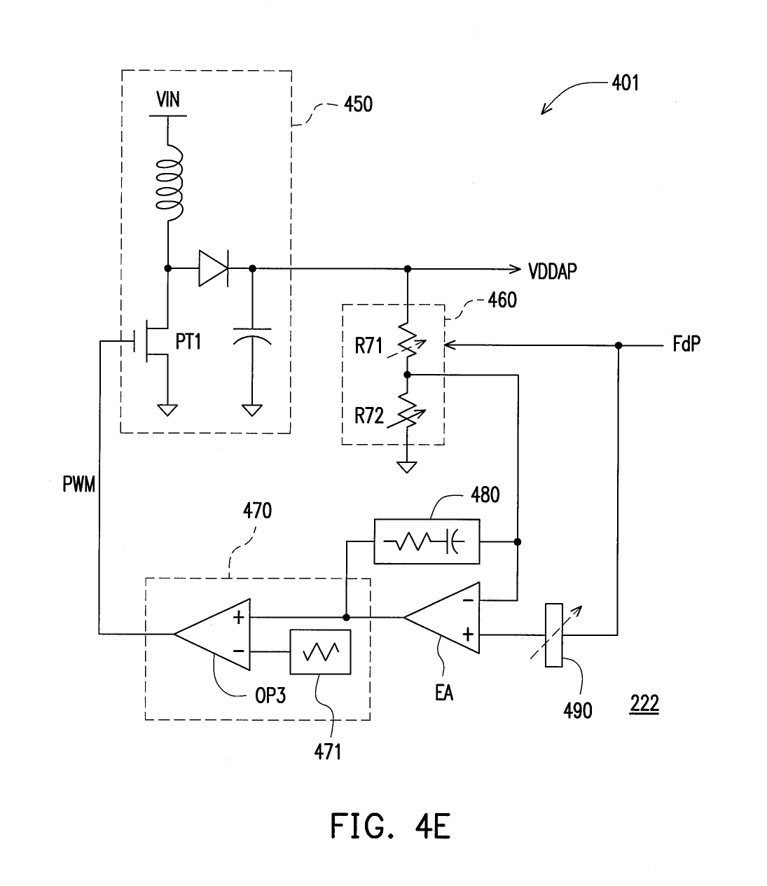

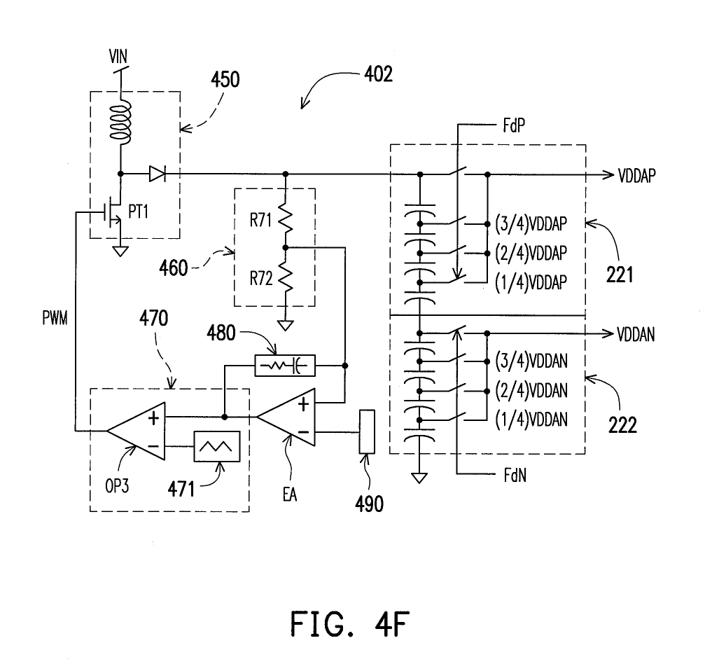

Referring to FIGS. 4A-4F, FIGS. 4A-4F are schematic diagrams showing different implementations of the positive-polarity power generating circuit and the negative-polarity power generating circuit in the embodiment of the invention. In FIG. 4A, a positive-polarity power generating circuit 221 includes a voltage-dividing circuit 410 and a unity-gain amplifier UG1. The voltage-dividing circuit 410 is electrically connected in series between a voltage source VCC and a ground terminal GND, receives the voltage source VCC and the positive-polarity control signal FdP and performs voltage-dividing on the voltage source VCC according to the positive-polarity control signal FdP to generate a divided voltage VAP. The unity-gain amplifier UG1 is coupled to the voltage-dividing circuit 410 and receives the divided voltage VAP to generate the positive-polarity driving power VDDAP.

In the embodiment, the voltage-dividing circuit 410 is formed by two variable resistors R51 and R52 electrically connected in series to each other, in which the voltage-dividing circuit 410 can adjust the resistance of at least one of the resistors R51 and R52 according to the received positive-polarity control signal FdP. The unity-gain amplifier UG1 receives the divided voltage VAP and enhances the driving capability of the divided voltage VAP to generate the positive-polarity driving power VDDAP. The positive-polarity driving power VDDAP herein has a same voltage as the divided voltage VAP.

In addition, a voltage-regulating capacitor Cp can be electrically connected in series between the output terminal of the unity-gain amplifier UG1 (the terminal to generate the positive-polarity driving power VDDAP) and the ground terminal GNDA.

The negative-polarity power generating circuit 222 in FIG. 4B has a same circuit configuration as the positive-polarity power generating circuit 221 in FIG. 4A, in which the voltage-dividing circuit 420 is formed by two resistors R53 and R54 electrically connected in series to each other, and the voltage-dividing circuit 420 generates the divided voltage VAN according to the negative-polarity control signal FdN. The unity-gain amplifier UG2 receives the divided voltage VAN and enhances the driving capability of the divided voltage VAN to generate the negative-polarity driving power VDDAN. In addition, a voltage-regulating capacitor Cn of the negative-polarity power generating circuit 222 is electrically connected in series between the output terminal of the unity-gain amplifier UG2 and the ground terminal GNDA.

The FIG. 4C shows another implementation of the positive-polarity power generating circuit 221. In FIG. 4C, the positive-polarity power generating circuit 221 includes an operational amplifier OP1 and a feedback circuit 430. An input terminal of the operational amplifier OP1 receives a reference voltage VREFP, the other input terminal thereof is coupled to the feedback circuit 430 and the output terminal thereof generates the positive-polarity driving power VDDAP. The feedback circuit 430 is also coupled to the output terminal of the operational amplifier OP1 for performs voltage-dividing on the positive-polarity driving power VDDAP according to the positive-polarity control signal FdP so as to generate the divided voltage VBP. The feedback circuit 430 transmits the generated divided voltage VBP to the input terminal of the operational amplifier OP1 where the feedback circuit 430 is coupled to.

The feedback circuit 430 herein is formed by two variable resistors R61 and R62 electrically connected in series to each other, in which the feedback circuit 430 can adjust the resistance of at least one of the resistors R61 and R62 according to the received positive-polarity control signal FdP. The voltage values on the two input terminals of the operational amplifier OP1 (the reference voltage VREFP and the divided voltage VBP) must be the same as each other. In order to realize the condition, the resistance of at least one of the resistors R61 and R62 can be changed so as to adjust the voltage value of the positive-polarity driving power VDDAP.

The negative-polarity power generating circuit 222 in FIG. 4D has a same circuit configuration as the positive-polarity power generating circuit 221 in FIG. 4C, in which the negative-polarity power generating circuit 222 of FIG. 4D adjusts the resistance of at least one of two resistors R63 and R64 in a feedback circuit 440 according to the negative-polarity control signal FdN and then, by means of the same mechanism between the reference voltage VREFN and the divided voltage VBN, adjusts the voltage value of the negative-polarity driving power VDDAN generated by the operational amplifier OP2.

The FIG. 4E shows yet another implementation of the positive-polarity power generating circuit 221. In FIG. 4E, the positive-polarity power generating circuit 221 is formed by a power converter 401 and the power converter 401 includes a power converting circuit 450, a voltage-dividing circuit 460, an error amplifier EA and a pulse-width modulation signal generating circuit 470. The power converting circuit 450 receives an input voltage VIN. The power converting circuit 450 has a power transistor PT1 and performs a voltage-boosting operation on the input voltage according to the turning on and the turning off of the power transistor PT1 so as to generate the positive-polarity driving power VDDAP.

The voltage-dividing circuit 460 is coupled to the output terminal of the power converting circuit 450 and performs voltage-dividing on the positive-polarity driving power VDDAP according to the positive-polarity control signal FdP. The voltage-dividing circuit 460 herein is formed by two resistors R71 and R72 and the voltage-dividing circuit 460 adjusts the resistance of at least one of the resistors R71 and R72 according to the positive-polarity control signal FdP so as to adjust the voltage-dividing result generated by the voltage-dividing circuit 460.

An input terminal of the error amplifier EA receives the voltage-dividing result of the voltage-dividing circuit 460. The other input terminal of the error amplifier EA receives the voltage generated by a reference voltage generator 490 according to the positive-polarity control signal FdP.

The pulse-width modulation signal generating circuit 470 receives a difference between the two voltages received by the two input terminals of the error amplifier EA so as to generate a pulse-width modulation signal PWM, which then is transmitted to the gate of the power transistor PT1 for controlling the switching operation of the power transistor PT1.

The pulse-width modulation signal generating circuit 470 includes an operational amplifier OP3 and a triangle wave generator 471, in which the operational amplifier OP3 compares the triangle wave signal generated by the triangle wave generator 471 with the voltage difference generated by the error amplifier EA so as to generate the pulse-width modulation signal PWM.

It should be noted that the error amplifier EA and the voltage-dividing circuit 460 are connected in series to an additional compensation circuit 480.

For forming the positive-polarity power generating circuit 221 by using the implementation of FIG. 4E, the corresponding negative-polarity power generating circuit 222 can be realized by using the implementation of FIG. 4B or FIG. 4D. However, the difference herein from the implementation of FIG. 4B or FIG. 4D that when the positive-polarity power generating circuit 221 is formed following the implementation of FIG. 4E and the negative-polarity power generating circuit 222 is formed following the implementation of FIG. 4B or FIG. 4D, the operational amplifier, the voltage-dividing circuit and the unity-gain amplifier herein should be coupled to the positive-polarity driving power VDDAP, not to the voltage source VCC as before.

The FIG. 4F shows yet another implementation of the positive-polarity power generating circuit 221 and the negative-polarity power generating circuit 222. In FIG. 4F, a power converter 402 includes a power converting circuit 450, a voltage-dividing circuit 460, an error amplifier EA and a pulse-width modulation signal generating circuit 470. The power converting circuit 450 receives an input voltage VIN. The power converting circuit 450 has a power transistor PT1 and performs a voltage-boosting operation on the input voltage according to the turning on and the turning off of the power transistor PT1. The voltage-dividing circuit 460 is coupled to the output terminal of the power converting circuit 450 and performs voltage-dividing on the output voltage of the power converting circuit 450. An input terminal of the error amplifier EA receives the voltage-dividing result of the voltage-dividing circuit 460. The other input terminal of the error amplifier EA receives the voltage generated by a reference voltage generator 490. The output terminal of the error amplifier EA and the voltage-dividing circuit 460 are connected in series to a compensation circuit 480. The voltage-regulating capacitors are used to implement the positive-polarity power generating circuit 221 and the negative-polarity power generating circuit 222, in which the positive-polarity power generating circuit 221 receives a positive-polarity control signal FdP in the control signal Fd, while the negative-polarity power generating circuit 222 receives a negative-polarity control signal FdN therein. The positive-polarity power generating circuit 221 and the negative-polarity power generating circuit 222 simultaneously and respectively generate a positive-polarity driving power VDDAP and a negative-polarity driving power VDDAN according to the positive-polarity control signal FdP and the negative-polarity control signal FdN.

It should be noted that the voltage-regulating capacitors Cp and Cn used in the positive-polarity power generating circuit and the negative-polarity power generating circuit in the above-mentioned implementations of FIGS. 4A-4D can be replaced by the set of capacitors connected in series in the positive-polarity power generating circuit 221 and the negative-polarity power generating circuit 222. In more details, taking FIG. 4A as an example, the voltage-regulating capacitor Cp can be replaced by a plurality of capacitors connected in series, in which the capacitors are connected in series between the positive-polarity driving power VDDAP and the ground terminal GNDA. The capacitors connected in series can perform voltage-dividing on the positive-polarity driving power VDDAP so that more voltage values of the driving voltages can be selected through a plurality of switches and the positive-polarity control signal FdP shown by FIG. 4F.

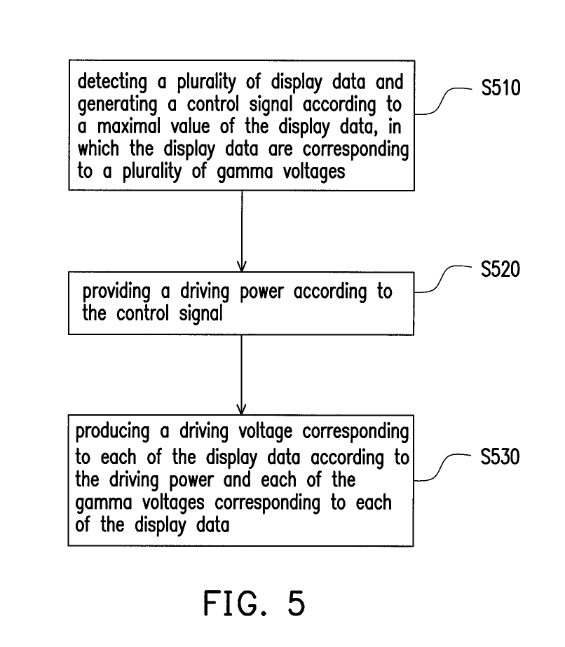

FIG. 5 is a flowchart of a driving method of display according to an embodiment of the invention. Referring to FIG. 5, the driving method includes following steps: first, detecting a plurality of display data and generating a control signal according to a maximal value of the display data (S510); next, providing a driving power according to the control signal (S520); then producing a driving voltage corresponding to each of the display data according to the driving power and each of the gamma voltages corresponding to each of the display data (S530). The details in the above-mentioned steps can refer to the above-mentioned embodiments and implementations, which are omitted for simplicity.

In summary, in the present invention, the display data detector is used to judge the maximal value of the display data and the driving power to be generated by the power controller is dynamically adjusted according to the gamma voltage to be generated corresponding to the maximal value. In this way, the driving power received by the source driver can be dynamically adjusted in response to the largest displaying luminance driven by the display, which effectively reduces the power consumption due to producing an inappropriate excessive driving power in the prior art.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A driving apparatus for display, comprising:
a display data detector, used for detecting a plurality of display data and generating a control signal according to a maximal value of the display data, wherein the display data are corresponding to a plurality of gamma voltages;
a power controller, coupled to the display data detector, receiving the control signal and providing a driving power according to the control signal; and
a source driver, coupled to the power controller, receiving the driving power as an operation power and generating a driving voltage corresponding to each of the display data according to the driving power and each of the gamma voltages.

2. The driving apparatus for display as claimed in claim 1, wherein the gamma voltages comprise a plurality of positive-polarity gamma voltages and a plurality of negative-polarity gamma voltages, the control signal comprises a positive-polarity control signal and a negative-polarity control signal and the driving power comprises a positive-polarity driving power and a negative-polarity driving power.

3. The driving apparatus for display as claimed in claim 2, wherein the display data detector calculates the positive-polarity gamma voltages and the negative-polarity gamma voltages corresponding to the display data, and the display data detector generates the positive-polarity control signal and the negative-polarity control signal respectively according to a maximal value among the differences between the positive-polarity gamma voltages and the common voltage and a maximal value among the differences between the negative-polarity gamma voltages and the common voltage.

4. The driving apparatus for display as claimed in claim 2, wherein the power controller comprises:
a positive-polarity power generating circuit, coupled to the display data detector, receiving the positive-polarity control signal and generating the positive-polarity driving power according to the positive-polarity control signal; and
a negative-polarity power generating circuit, coupled to the display data detector, receiving the negative-polarity control signal and generating the negative-polarity driving power according to the negative-polarity control signal.

5. The driving apparatus for display as claimed in claim 4, wherein
the positive-polarity power generating circuit comprises:
a first voltage-dividing circuit, receiving the positive-polarity control signal, performing voltage-dividing on the voltage source according to the positive-polarity control signal and generating a first divided voltage; and
a first unity-gain amplifier, coupled to the first voltage-dividing circuit and receiving the first divided voltage so as to generate the positive-polarity driving power;
the negative-polarity power generating circuit comprises:
a second voltage-dividing circuit, receiving the negative-polarity control signal, performing voltage-dividing on a voltage source according to the negative-polarity control signal and generating a second divided voltage; and
a second unity-gain amplifier, coupled to the second voltage-dividing circuit and receiving the second divided voltage so as to generate the negative-polarity driving power.

6. The driving apparatus for display as claimed in claim 4, wherein
the positive-polarity power generating circuit comprises:
a first operational amplifier, having a first input terminal for receiving a first reference voltage, a second input terminal, and an output terminal for generating the positive-polarity driving power; and
a first feedback circuit electrically connecting in series between the output terminal of the first operational amplifier and the second input terminal of the first operational amplifier for performing voltage-dividing on the positive-polarity driving power according to the positive-polarity control signal so as to generate a first divided voltage, wherein the first feedback circuit further transmits the first divided voltage to the second input terminal of the first operational amplifier;
the negative-polarity power generating circuit comprises:
a second operational amplifier, having a first input terminal for receiving a second reference voltage, a second input terminal, and an output terminal for generating the negative-polarity driving power; and
a second feedback circuit electrically connecting in series between the output terminal of the second operational amplifier and the second input terminal of the second operational amplifier for performing voltage-dividing on the negative-polarity driving power according to the negative-polarity control signal so as to generate a second divided voltage, wherein the second feedback circuit further transmits the second divided voltage to the second input terminal of the second operational amplifier.

7. The driving apparatus for display as claimed in claim 4, wherein
the positive-polarity power generating circuit comprises:
a power converter, coupled to the display data detector, receiving the positive-polarity control signal, and performing a voltage-boosting operation on an input voltage according to the positive-polarity control signal so as to generate the positive-polarity driving power.

8. The driving apparatus for display as claimed in claim 4, wherein the negative-polarity power generating circuit comprises:
a first operational amplifier, having a first input terminal for receiving a first reference voltage, a second input terminal, and an output terminal for generating the negative-polarity driving power; and
a first feedback circuit electrically connecting in series between the output terminal of the first operational amplifier and the second input terminal of the first operational amplifier for performing voltage-dividing on the negative-polarity driving power according to the negative-polarity control signal so as to generate a first divided voltage, wherein the first feedback circuit further transmits the first divided voltage to the second input terminal of the first operational amplifier,
wherein the first operational amplifier receives the positive-polarity driving power as the operation power thereof.

9. The driving apparatus for display as claimed in claim 4, wherein the negative-polarity power generating circuit comprises:
a first voltage-dividing circuit, receiving the negative-polarity control signal, performing voltage-dividing on the negative-polarity driving power according to the negative-polarity control signal and generating a first divided voltage; and
a first unity-gain amplifier, coupled to the first voltage-dividing circuit and receiving the first divided voltage so as to generate the negative-polarity driving power,
wherein the first unity-gain amplifier receives the positive-polarity driving power as the operation power thereof.

10. The driving apparatus for display as claimed in claim 7, wherein the power converter comprises:
a power converting circuit, receiving the input voltage, having a power transistor, performing a voltage-boosting operation on the input voltage according to turning on and turning off of the power transistor and thereby generating the positive-polarity driving power;
a voltage-dividing circuit, coupled to the power converting circuit and performing voltage-dividing on the positive-polarity driving power according to the positive-polarity control signal;
an error amplifier, having an input terminal and an output terminal, wherein the input terminal respectively receives a voltage-dividing result of the voltage-dividing circuit and a reference voltage; and
a pulse-width modulation signal generating circuit, coupled to the output terminal of the error amplifier and generating a pulse-width modulation signal according to the voltage at the output terminal of the error amplifier, wherein the pulse-width modulation signal is for turning on or off the power transistor.

11. The driving apparatus for display as claimed in claim 7, wherein the power converter comprises:
a power converting circuit, receiving the input voltage, having a power transistor, performing the voltage-boosting operation on the input voltage according to turning on and turning off of the power transistor and thereby generating the positive-polarity driving power;
a voltage-dividing circuit, coupled to the power converting circuit and performing voltage-dividing on the positive-polarity driving power;
an error amplifier, having a first input terminal, a second input terminal and an output terminal, wherein the first input terminal receives a voltage-dividing result of the voltage-dividing circuit, the second input terminal is coupled to a reference voltage, wherein the reference voltage is adjusted according to the positive-polarity control signal; and
a pulse-width modulation signal generating circuit, coupled to the output terminal of the error amplifier and generating a pulse-width modulation signal according to the voltage at the output terminal of the error amplifier, wherein the pulse-width modulation signal is for turning on or off the power transistor.

12. The driving apparatus for display as claimed in claim 7, wherein the power converter comprises:
a power converting circuit, receiving the input voltage, having a power transistor and performing the voltage-boosting operation on the input voltage according to turning on and turning off of the power transistor;
a voltage-dividing circuit, coupled to the power converting circuit and performing voltage-dividing on the positive-polarity driving power;
an error amplifier, having an input terminal and an output terminal, wherein the input terminal respectively receives a voltage-dividing result of the voltage-dividing circuit and a reference voltage;
a pulse-width modulation signal generating circuit, coupled to the output terminal of the error amplifier and generating a pulse-width modulation signal according to the voltage at the output terminal of the error amplifier, wherein the pulse-width modulation signal is for turning on or off the power transistor; and
a voltage-regulating capacitor, receiving the positive-polarity control signal and the negative-polarity control signal and generating the positive-polarity driving power and the negative-polarity driving power respectively according to the positive-polarity control signal and the negative-polarity control signal.

13. A driving method of display, comprising:
detecting a plurality of display data and generating a control signal according to a maximal value of the display data, wherein the display data are corresponding to a plurality of gamma voltages;
providing a driving power according to the control signal; and
producing a driving voltage corresponding to each of the display data according to the driving power and each of the gamma voltages.

14. The driving method of display as claimed in claim 13, wherein the gamma voltages comprise a plurality of positive-polarity gamma voltages and a plurality of negative-polarity gamma voltages, the control signal comprises a positive-polarity control signal and a negative-polarity control signal, and the driving power comprises a positive-polarity driving power and a negative-polarity driving power.

15. The driving method of display as claimed in claim 14, wherein the step of detecting the display data and generating the control signal according to the maximal value of the display data comprises:
calculating the positive-polarity gamma voltages and the negative-polarity gamma voltages corresponding to the display data; and
generating the positive-polarity control signal and the negative-polarity control signal respectively according to a maximal value among the differences between the positive-polarity gamma voltages and a common voltage and a maximal value among the differences between the negative-polarity gamma voltages and the common voltage.
